(19) United States
(12) Patent Application Publication
(10) Pub. No.: US 2010/0043076 A1
(43) Pub. Date: Feb. 18, 2010

(54) System and Method for Encoding and Authentication

(76) Inventor: Philip Wesby, Tiddington (GB)

Correspondence Address: Sunstein Kann Murphy & Timbers LLP, 125 SUMMER STREET, BOSTON, MA, 02110-1618, US

(21) Appl. No.: 12/525,395

(22) PCT Filed: Feb. 1, 2008
(86) PCT No.: PCT/GB2008/000327

§ 371 Date: Jul. 31, 2009

(30) Foreign Application Priority Data
Feb. 2, 2007 (GB) 0702012.6

(51) Int. Cl. H04L 9/32

(52) U.S. Cl. 726/26

(57) ABSTRACT

A system and method for encoding documents and data storage discs uniquely is described which can provide a means to authenticate a document such as a passport or identification document or driving licence or contract or a music compact disc (CD) or data CD or DVD or holographic DVD or credit card. The method makes possible the encoding of a unique number or pattern or datagram image in or into the surface of the document or CD or upon a label or foil or hologram associated with and firmly adhered to the document or CD during the manufacturing process of the document or CD itself. The encoding may be made with a laser device which cuts the unique number or pattern or datagram image into a hologram foil which is firmly attached to the document or CD. Alternatively, in the case of documents, the encoding may comprise a unique number or pattern or datagram image which is cut by laser to create a perforation into the document thereby leaving the unique number or pattern or datagram as a matrix of small holes or perforations in the document through which light may pass. To authenticate the document or compact disc or credit card, the unique encoding is read by a suitable device and processed to extract data from it and to generate a dataset which is compared with a number or pattern or character string printed on the document or CD, or stored as a data set on the CD to determine the authenticity of the said document or CD or credit card.

### BACKGROUND OF THE INVENTION

The current invention relates to a system and method for encoding and authentication of documents and data storage compact discs or music storage compact discs (CDs) or DVDs or holographic DVDs or credit cards.

In particular, the invention relates to a system and method for encoding documents or CDs or credit cards with a unique pattern or number or alphanumeric sequence or datagram or a sequence of characters in any language character set as a means to authenticate the documents or CDs.

More particularly, when applied to paper documents, the invention relates to a system and method for encoding documents such as passports, driving licences, personal identification documents, contracts, deeds of ownership, promissory notes and the like, wherein a laser device is used to encode documents with an authenticating unique number or pattern or datagram during the manufacturing process. The method involves encoding the documents by using a laser device to cut the unique number or pattern or datagram into a surface feature of the document such as a holographic foil which is firmly adhered to the document, and or to cut the unique number or pattern or datagram as a matrix of very small holes into the document itself to leave the encoding as a perforation matrix in the document through which light may pass.

When applied to data storage CDs such as those containing software programs or to music CDs such as those containing music, the invention comprises using a laser cutting technique to cut the unique number or pattern or datagram into a surface feature of the CD such as a holographic foil which is firmly adhered to the CD itself or to the outer packaging containing the CD, or alternatively the laser cut creates an encoding into the surface of the CD itself.

This patent application relates in part to an invention of an earlier patent application United Kingdom Patent Application 0619761.0 by the same applicant entitled System and Method for Data Acquisition and Processing having priority date Oct. 6th 2006. In this patent application is taught the method of using datagrams and combining these with user profiles stored within the data capture device, such as a mobile phone or PDA, to create a range of differentiated services.

The current invention can also be considered as one further application of the use of datagrams according to one embodiment of the current invention.

To help clarify the invention the two problem areas relating to document authenticity and software program and music CD authenticity are described separately.

Today, passports and other identification documents form an integral means to authenticate people and validate their right of entry into and right of exit from different countries of the world. Identity theft is increasing and means to further reduce the misuse of forged documents are sought by authorities. The current invention relates directly to a means to improve document security.

Most types of documents comprise images and text which can be copied easily by readily available high quality colour photocopying equipment and inkjet printers.

The current invention addresses this problem by introducing a process which cannot easily be replicated because it is based upon a technique which does not use readily available equipment. Furthermore this process comprises a modification which can be made to an existing document production process. The process involves using a laser to cut a unique encoded pattern or sequence of characters into the document itself in the form of a perforation matrix of very small holes. In addition or alternatively, a unique encoded pattern or sequence of characters may be cut using a laser into an OVD or optically variable device such as a holographic foil which is firmly adhered to the document.

Generally, identification documents undergo a staged manufacturing process which comprises rigorous quality control checks throughout. Only documents passing the scrutiny of each of the separate quality control checks may be used to create personal identification documents. Consequently, it is only in the final phase of production that documents receive numbers or sequential authenticating codes.

When proposing any improvements to an existing authentic document production process, the existing process must be thoroughly understood if the improvements are to be introduced without requiring any significant changes to the process which would otherwise be prohibitively expensive to implement.

The current authentic document production process generally involves eight main processes. Each of these processes is performed by complex and expensive machinery. Generally, the production process comprises paper substrate preparation including providing a watermark and or security threads to the document [1], offset printing of the front and back of the document [2], provision of features using an optically variable ink, or OVI [3], provision of an optically variable device such as a holographic foil, or OVD [4], intaglio printing of features of the document on the back of the document [5], intaglio printing of features of the document on the front of the document [6], final inspection of the documents for pass or reject [7], and sequential or non-sequential numbering of the quality-approved documents [8].

Between each of these phases the documents are stored and dried for a sufficient time interval.

The challenge to introduce an encoding of the manufactured documents which provides increased authenticity is that there is no guaranteed correspondence between the sequence of documents passing any phase of the process and the sequence of the quality-approved documents which are ultimately numbered.

Rigorous quality control checks may remove any documents due to them not being of sufficient quality. Consequently, it is not possible to introduce a unique encoding which will be associated with a unique number on the document prior to the final quality control check before final approved documents are passed to the numbering process.

Only documents which reach the numbering process are quality-approved for use. Consequently, the invention directly addresses this aspect and the system and method of the invention is introduced as an addition to the numbering phase of the manufacturing process.

In the instance of software program CD authenticity or music CD authenticity, consumers often wish to know that the product is authentic and from a genuine source. The invention provides an encoding method which can be applied to holographic foils which may be attached to the outer packaging of the CDs and or to the CD itself by cutting a unique encoding into the surface of the CD adjacent to the centre and away from the data storage part of the CD.

Further to the limitations of existing methods used for enhancing document security, and methods used for enhancing CD authenticity, and so far as is known, no optimum system and method for uniquely encoding documents or CDs using a laser cutting method is presently available which is directed towards the specific needs of this problem area as outlined.

### OBJECTS OF THE INVENTION

Accordingly, it Is an object of the present invention to provide an improved system and method for encoding documents such as a passport or identification document or driving licence or contract or promissory note or bank note and the like, in which a unique number or pattern or datagram image or sequence of characters in any language is encoded in or onto the surface of a document or upon a label or foil or hologram or Optically Variable Device (OVD) associated with, and firmly adhered to, the document, or encoded as a perforation matrix into the document.

It is a further object of one embodiment of the present invention to provide a system and method for encoding documents in which a unique encoding comprising a number or pattern or datagram image or sequence of characters in any language is encoded by way of a laser process wherein the laser cuts the said unique encoding into an optically variable device at the end of the document manufacture process.

It is a further object of one embodiment of the present invention to provide a system and method for encoding documents in which a unique encoding comprising a number or pattern or datagram image or sequence of characters in any language is encoded by way of a laser process wherein the laser cuts the said unique encoding as a series of very small holes in the form of a matrix perforation.

It is a further object of one embodiment of the present invention to provide a system and method for encoding documents in which a unique encoding comprising a number or pattern or datagram image or sequence of characters in any language is encoded by way of a laser process wherein the laser cuts the said unique encoding as a series of very small holes in the form of a matrix perforation and wherein the laser cutting process takes place in conjunction with the document numbering process.

It is a further object of one embodiment of the present invention to provide a system and method for encoding documents in which a unique encoding comprising a number or pattern or datagram image or sequence of characters in any language is encoded by way of a laser cutting process wherein the laser cuts the said unique encoding as a series of very small holes in the form of a matrix perforation into the document or writes into the surface of an Optically Variable Device such as a holographic foil and wherein the encoding is linked directly to the numbering process such that there is a correspondence between a unique number or pattern or dataset printed on the document and the unique encoding by the laser cutting process.

It is a further object of one embodiment of the present invention to provide a system and method for encoding documents in which a unique encoding comprising a number or pattern or datagram image or sequence of characters in any language is encoded by way of a laser process wherein the laser cuts the said unique encoding as a series of very small holes in the form of a matrix perforation into the document or into the surface of an Optically Variable Device adhered to the document and wherein the unique encoding by the laser cutting process is generated from the number which is printed upon the document.

It is a further object of one embodiment of the present invention to provide a system and method for encoding documents wherein a unique number to be printed upon a document is sent to a computer controlled laser cutting device which generates a unique encoding associated with this number and then cuts this unique encoding into an OVD adhered to the document or into the document itself as a matrix perforation such each document comprises a different unique encoding which is directly related to the number printed on the document.

It is a further object of one embodiment of the present invention to provide a system and method for encoding documents wherein the process of cutting a unique encoding into a document occurs after the document has passed all quality control checks and in conjunction with the document numbering process.

It is a further object of one embodiment of the present invention to provide a system and method for encoding documents which comprises using a laser to cut a unique encoding in the form of a number or sequence of characters or a datagram or a pattern of holes into an OVD or as a perforation matrix in the document wherein the pattern of laser cuts may comprise a matrix of very small holes such as between 2 mm and 0.5 mm in diameter and of optimum spacing so that the encoding can be read.

It is a further object of one embodiment of the present invention to provide a system and method for encoding documents which comprises using a laser to cut a unique encoding in the form of a number or sequence of characters or a datagram or a pattern of holes into an OVD or as a perforation matrix in the document wherein the perforation matrix can be read by shining light through the document and or the encoding of the OVD can be read by reflecting light from the encoded OVD and wherein the read encoding is compared with the number printed on the document.

It is a further object of one embodiment of the present invention to provide a system and method for encoding documents wherein the authenticity of each encoded document is determined by comparing the encoding with the number printed on the document.

It is a further object of one embodiment of the present invention to provide a system and method for encoding documents wherein the authenticity of each encoded document is determined by first reading the unique encoding which can comprise a number or a non-obvious encoding such as a datagram or barcode or string of alphanumeric characters and then by processing this unique encoding to extract data from it and generate a dataset wherein the dataset is compared with the number printed on the document and if the number matches the dataset then the document's authenticity is validated.

It is a further object of one embodiment of the present invention to provide a system and method for encoding documents wherein the laser cutting cuts perforations comprising a matrix of cuts of very small holes of different shapes such as holes in the shape of circles, or ellipses, or triangles, or squares, or other geometric forms or as a combination of these shapes.

It is a further object of one embodiment of the present invention to provide a system and method for encoding electronic data storage discs such as software compact discs and or music compact discs and or DVDs and or holographic DVDs by applying the method of the invention to cut a unique encoding with a laser into the surface of the compact disc or into an OVD associated with the compact discs or DVDs.

It is a further object of one embodiment of the present invention to provide a system and method for encoding data storage discs (CDs and DVDs) wherein the authenticity of each document and or data storage disc is determined by reading the encoding using an optical device, creating a dataset based upon this encoding and comparing this dataset with a unique pattern or character string or datagram printed on the document or data storage disc.

Other objects and advantages of this invention will become apparent from the description to follow when read in conjunction with the accompanying drawings.

### BRIEF SUMMARY OF THE INVENTION

Certain of the foregoing and related objects are readily-attained according to the present invention by the provision of a novel system and method for encoding documents and data storage discs uniquely for the purpose of improving their authenticity. This invention is directly applicable to travel documents such as passports, and personal identification documents such as driving licences, pilot licences, contracts, promissory notes, bank notes, marriage certificates, birth certificates, lottery tickets as well as to music storage compact discs (CDs), data storage CDs, DVDs and holographic DVDs.

A unique number or pattern such as an encoded datagram image is cut into the surface of the document or CD or upon a label or foil or hologram or OVD associated with and firmly adhered to the document or CD during the manufacturing process of the document or CD itself. The encoding may be made with a laser device or other suitable device. Alternatively, in the case of documents, the process may create an encoded perforation into the document thereby leaving the unique number or pattern or datagram as a matrix of small holes or perforations in the document through which light may pass. To authenticate the document or compact disc, the unique encoding is read by a suitable device and processed to extract data from it and to generate a dataset which is compared with a number or character string printed on the document or CD, or stored as a data set on the CD to determine the authenticity of the said document or CD.

Other objects and features of the present invention will become apparent from the following detailed description considered in connection with the accompanying drawings, which disclose several key embodiments of the invention. It is to be understood, however, that the drawings are designed for the purpose of illustration only and that the particular applications are given by way of example only and do not limit the scope of the invention.

### BRIEF DESCRIPTION OF THE DRAWINGS

FIG. 1 illustrates a schematic showing an example of a document comprising an encoding according to one embodiment of the invention.

FIG. 2 illustrates a schematic showing an example of a document comprising an encoding according to a second embodiment of the invention.

FIG. 3 illustrates a schematic showing the process of encoding.

FIG. 4 illustrates a schematic showing the process of authentication.

### DESCRIPTION OF A PREFERRED EMBODIMENT

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as defined by the appended claims. The following description makes full reference to the detailed features as outlined in the objects of the invention.

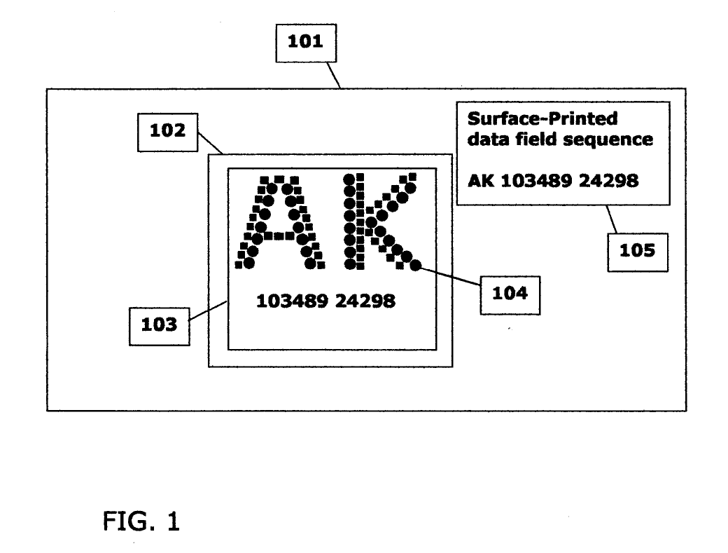

Referring now in detail to the drawings and in particular FIG. 1 thereof, therein illustrated is a schematic showing an example of a document comprising an encoding according to one embodiment of the invention.

In this first example which is suitable for a paper document, the document (101) such as a certificate or promissory note which is made of durable paper comprises a central area (102) which has cut into it an encoding. This encoding comprises a sequence of characters which is cut through the paper using a computer controlled laser device such that the encoding comprises a matrix perforation (103). This matrix perforation (103) comprise a pattern of very small holes (104) cut in close proximity with a constant or variable spacing to create a sequence of alphanumeric characters or geometric shapes or other language characters. The perforation matrix is located centrally so that the document is not substantially weakened. Typically, normal handling of this document will not cause any wear and tear to this central area (102) of the document.

On a separate part of the document there is printed a data field sequence (105) which comprises a unique reference number or an alphanumeric string or another language character sequence. There is a specific relation between the printed data field sequence and the encoded perforation matrix. In certain instances the relation may remain confidential. For example, if the perforation matrix is formed from a datagram sequence of geometric shapes or language characters which relate to a printed unique number on the document, this provides security against reproductions and a means to verify the authenticity of the document.

In fact, in some instances, the perforation matrix itself may be read by a laser which is capable of determining the shapes of the perforation holes. These holes may not be circular but ellipsoidal or of other geometric shapes and even, where appropriate, of different sizes.

In other instances, there may be a simple correlation between the perforation matrix and a printed number sequence on the document, such that the number sequence is identical in part, or completely, to the perforation matrix. In this way, a person can read the number and view the perforation matrix and thereby determine that the two are identical or clearly correspond to each other.

One particular key aspect of the invention is in the use of a laser to cut perforation holes of really small size such that the holes may be less than 1 mm in diameter. In some instances, the holes may be less than 0.5 mm in diameter.

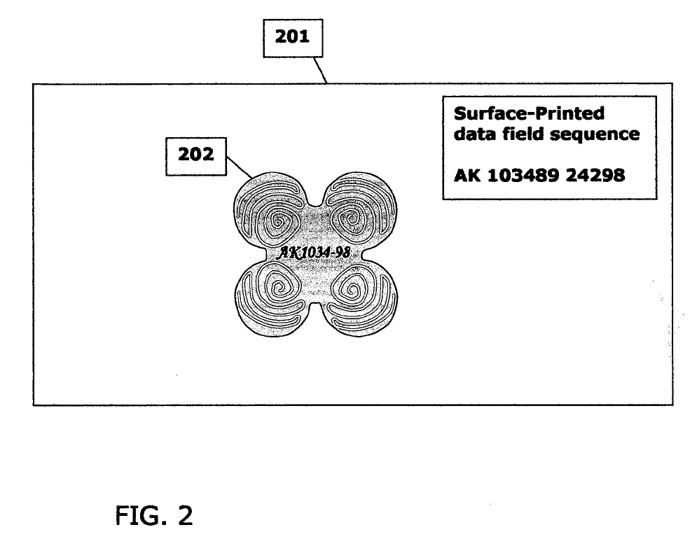

Now with reference to FIG. 2 is shown a schematic showing an example of a document comprising an encoding according to a second embodiment of the invention.

In this example, the document (201) is shown bearing a foil (202) such as a holographic foil which bears an encoded hologram. Such a foil is referred to as an Optically Variable Device or OVD because it changes its appearance when viewed from a different angle. In particular, the use of an OVD is equally suitable for application to documents as to data storage discs such as CDs or DVDs. In some instances the OVD may be fully incorporated into the surface of the CD or DVD or credit card.

In the use of documents and credit cards and CDs and DVDs which incorporate the encoding according to the invention, the invention can determine their authenticity before use. For example, the reading of a software program or data from a CD or DVD may be preempted by the reading of the encoded information to determine that the disc is authentic. In this way the program code or stored data may comprise encrypted data which is decrypted when read by a reading device and which is combined with encoded information read from the surface of the disc.

The OVD may be attached to the surface of a credit card or incorporated into the card itself. The OVD is then encoded according to the invention and the acceptance of a credit card or a bank note bearing such an encoded OVD foil by an automated payment machine such as a vending machine or a car park ticket machine or the like would then be dependent upon verifying the authenticity of the said credit card or bank note. In this example, the credit card reading machine is provided with a device which is able to read the surface features of the encoded OVD foil or surface of the credit card itself in addition to any magnetically encoded information which may be present.

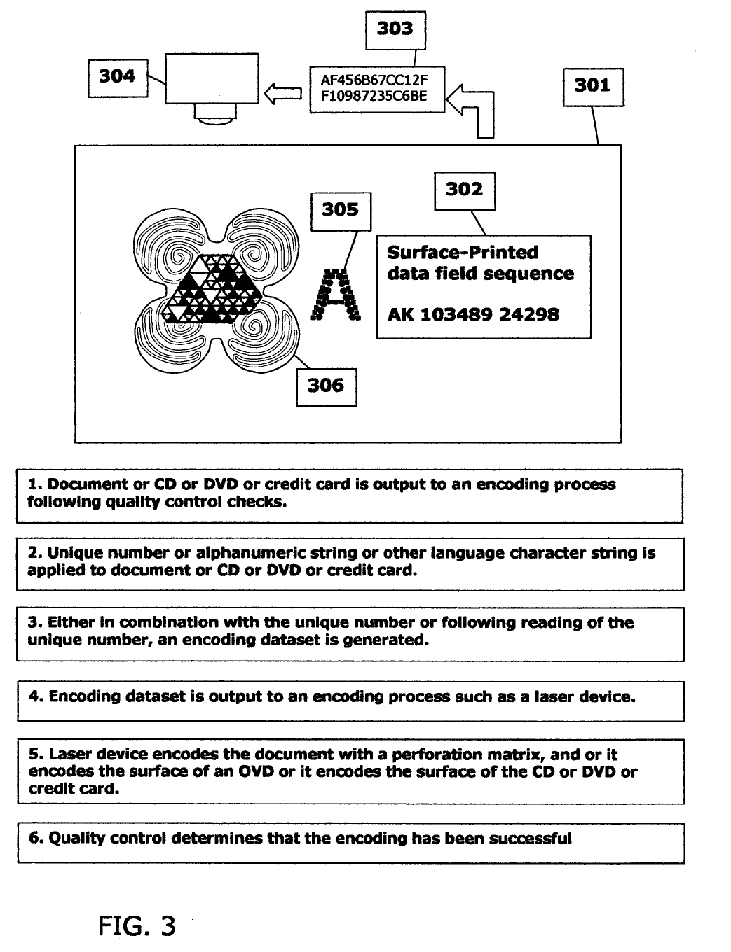

Now with reference to FIG. 3 is shown the sequence of steps which enables the encoding of the document or holographic foil or other OVD or other surface feature.

A key aspect of the invention is in providing a sequence of steps which enables documents to be encoded while making minimal changes to the manufacturing process of the documents or CDs or DVDs or credit cards and the like.

With reference to the document production process and the creation of an encoded perforation matrix and with reference to the production of data storage CDs and or to data storage DVDs and or to credit cards, the following steps are utilised.
1. The document (301) or CD or DVD or credit card is output to an encoding process following substantial quality control checks.
2. A unique number or any suitable alphanumeric string or other language character string (302) is applied to the document or CD or DVD or credit card.
3. Either in combination with the unique number (302) or following reading of the unique number, an encoding dataset (303) is generated.
4. The encoding dataset (303) is output to an encoding process such as a laser device (304) which is capable of encoding the document or CD or DVD or credit card.
5. The laser device (304) encodes the document with a perforation matrix (305) or it encodes the surface of an OVD (306) such as a holographic foil which is firmly attached to the surface of the document or CD or DVD or credit card, or it encodes the surface of the CD or DVD or credit card.
6. A final quality control check determines that the encoding has been successful.

The key application of the invention is in the provision of an improved validation process to determine that the document or CD or DVD or credit card is authentic. Consequently, the type of unique encoding employed in any particular application is chosen to facilitate the optimum authentication process. For example, a travel document or promissory note may be encoded directly with the same number or alphanumeric string or other language string (302) that was printed directly on the surface during the numbering process as outlined in step (2) above. Credit cards may be encoded with a sequence of characters or numbers which relate to a magnetic encoding of the card itself. The same process may be applied to other payment cards such as car park cards or to restaurant cards which can be loaded with credit and also to ‘chip and PIN’ cards.

Whenever an encoded datagram is used such as a sequence of geometrical elements and barcode lines and the like, the direct correspondence between the numbering on the surface of the document or CD or DVD or credit card and the datagram will be very complex. The use of the datagram encoding and the relation to any surface-printed information may remain confidential to improve the authentication of the document or CD or DVD or credit card. The device reading the datagram will comprise the capability to analyse the datagram and to determine that there is a correct correspondence between the datagram and the surface-printed information.

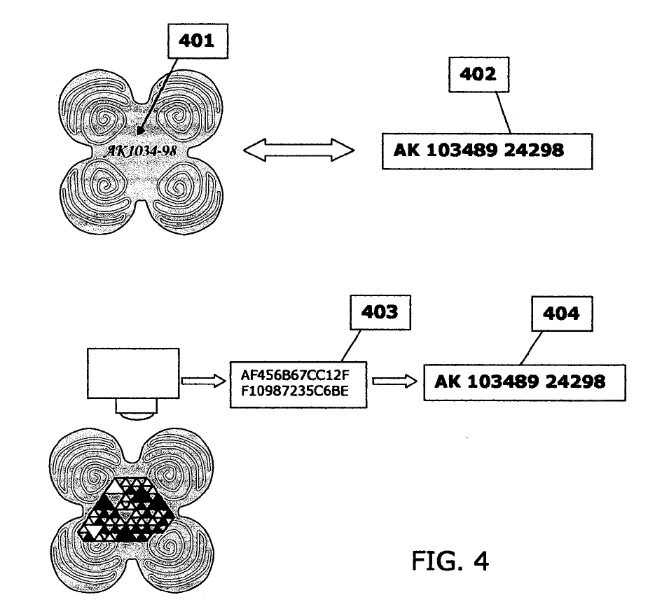

Now with reference to FIG. 4 is shown the sequence of steps which may be employed to authenticate the document or CD or DVD or credit card.

In a first level of authentication, where there is a direct one-to-one correspondence between the encoding (401) and all or part of the unique printed surface information (402), the perforation matrix or encoded OVD or encoded surface feature may be visibly inspected to check that the encoding (401) matches the surface information (402).

In a second level of authentication, the surface encoding or the perforation matrix is read by an optical reading device such as a laser reading device and a dataset is generated by the reading process. This dataset may be output to a screen where an operator may compare the dataset with the printed surface information. Alternatively, or in addition, the surface information may be read automatically and the dataset may be then directly compared with the read surface information.

In a third level of authentication, the surface encoding is processed to extract the data within it which may be a derivative of the stored information.

In different applications whenever the dataset derived from the encoding does not match the surface-printed information the document may be identified as non-authentic and additional information may be subsequently encoded into the document to render it void. Alternatively, the document may be printed with the word void across it. Any CDs and or DVDs and or credit cards which are determined to be void may also have data encoded into their surface to clearly indicate that they are non-authentic.

While the present invention has been described herein with reference to particular embodiments thereof, a latitude of modification, various changes, and substitutions are intended in the present invention. In some instances, features of the invention can be employed without a corresponding use of other features, without departing from the scope of the invention as set forth. Therefore, many modifications may be made to adapt a particular configuration or method disclosed, without departing from the essential scope and spirit of the present invention. It is intended that the invention not be limited to the particular embodiments disclosed, but that the invention will include all embodiments and equivalents falling within the scope of the claims.

What is claimed is:

1-16. (canceled)

17. A system for encoding and authenticating documents characterised by:
a. an encoding of an area of a document, wherein said encoding further comprising:
a unique number or pattern or barcode or barcode lines or datagram image or sequence of characters in any language or sequence of geometrical elements,
or a matrix perforation comprising a pattern of very small holes,
or a pattern cut in close proximity with a constant or variable spacing forming a sequence of characters on the document,
or a surface encoding of a holographic foil, or label or hologram,
or laser writing into the surface of an Optically Variable Device
wherein said characters forming a sequence of alphanumeric characters or one or a plurality of predetermined geometric shapes or of any other language characters, and/or wherein said matrix perforation being formed from a datagram sequence of geometric shapes or language characters, and
b. a data field sequence comprising a unique reference number or an alphanumeric string or another language character sequence further comprising a specific relation between said data field sequence and said encoding for providing security against reproductions and a means to verify the authenticity of said document.

18. A system for encoding and authenticating documents as disclosed in claim 17 wherein said perforation matrix comprising very small holes being less than 1 mm in diameter or less than 0.5 mm in diameter, and said perforation matrix being further read by a laser capable of determining the shapes of said perforation holes wherein said holes being ellipsoidal or of other geometric shapes and/or of different sizes.

19. A system for encoding and authenticating documents as disclosed in claim 17 wherein said document being a certificate or a promissory note or a passport or a bank note or an excise duty stamp or a product packaging or a personal identification document or a driving licence or a pilot licence or a marriage certificate or a birth certificate or a lottery ticket.

20. A system for encoding and authenticating documents as disclosed in claim 17 characterised in that: said document further bearing a foil being an Optically Variable Device (OVD) wherein said foil being a holographic foil further bearing an encoded hologram changing its appearance when viewed from different angles.

21. A system for encoding and authenticating documents as disclosed in claim 20 wherein said encoded document being adhered to or the encoding is cut into the surface of a data storage disc or a CD or a DVD or a credit card or bank note wherein said OVD being fully incorporated into the surface of said data storage disc or CD or DVD or credit card or a bank note.

22. A system for encoding and authenticating documents as disclosed in claim 21 further comprising a reading device for analysing said encoded information to determine that said document is authentic before use.

23. A system for encoding and authenticating documents as disclosed in claim 22 wherein said reading device further combining encrypted data from said CD or CVD or credit card or bank note or personal ID or document or packaging with encoded information read from the surface (OVD) of said CD or CVD or credit card or bank note or personal ID or document or packaging, and/or said document reading device being provided with a means which is able to read the surface features of the encoded OVD foil or surface of the CD or CVD or credit card or bank note or personal ID or document or packaging itself wherein said OVD being incorporated into the document itself.

24. A system for encoding and authenticating documents as disclosed in claim 23 wherein an automated payment machine comprising means for reading said encoded foil or surface encoding for verifying the authenticity of said credit card or bank note wherein said automated payment machine being a vending machine or a ticket machine.

25. A method for encoding and authenticating documents characterised by the steps of;
1) outputting said document or CD or DVD or credit card or product packaging or personal identification document or driving licence or excise duty stamp or pilot licence or marriage certificate or birth certificate or lottery ticket to an encoding process,
2) generating an encoding dataset either in combination with a unique number associated with said document or following reading of a unique number associated with said document,
3) encoding said document with a unique number and or pattern and or datagram image and or sequence of characters in any language or with a perforation matrix or encoding an OVD such as a holographic foil which is firmly attached to the surface of said document or CD or DVD or credit card, or encoding the surface of said document or CD or DVD or credit card by a laser device.

26. A method for encoding and authenticating documents as disclosed in claim 25 wherein said encoding providing an authentication process
wherein in said step 2), a document being encoded directly with a unique number and or an alphanumeric string and or other language string and or barcode and or datagram
wherein said number or alphanumeric string or other language string or barcode or datagram being a derivative of the unique number or alphanumeric string or other language string or barcode or datagram that was printed on the surface of said document or encoded into the surface during the numbering process,
or a credit card or other payment card being encoded with a sequence of characters or numbers relating to, or being a derivative of, a magnetic encoding of the card itself.

27. A method for encoding and authenticating documents as disclosed in claim 26 wherein said payment cards being car park cards or restaurant cards being loaded with credit and ‘chip and PIN’ cards.

28. A method for encoding and authenticating documents according to claim 25 wherein said encoding providing an authentication process wherein
a document being encoded directly with a unique number and or an alphanumeric string and or other language string and or barcode and or datagram
wherein said unique number or alphanumeric string or other language string or barcode or datagram being a derivative of the number or alphanumeric string or other language string or barcode or datagram that was printed on the surface of said document or encoded into the surface during the numbering process,
or a credit card or other payment card being encoded with a sequence of characters or numbers relating to, or being a derivative of, a magnetic encoding of the card itself, and
wherein said authentication process comprises capturing and or processing the unique number and or an alphanumeric string and or other language string and or barcode and or datagram to create a dataset,
and or sending the dataset to a server for processing
and determining the derivative code of the dataset,
and comparing the derivative code with the encoding on the document
wherein the document is determined to be authentic if the derivative code matches the encoded surface information.

29. A method for encoding and authenticating documents according to claim 28 wherein the document encoding is captured using a mobile phone or PDA or optical reading device or wireless camera and wherein the server processes the sent dataset and determines the derivative code and wherein the document is determined to be authentic if the derivative code matches the encoded surface information.

30. A method for encoding and authenticating documents characterised by the steps of:
visually inspecting an encoding of a document or a perforation matrix or an encoded Optically Variable Device (OVD) or an encoded surface feature of said document or product packaging, or personal identification document CD or DVD or credit card,
and determining that there is a correct one-to-one correspondence with the encoding and the surface information,
or reading by an optical reading device such as a laser, or by capturing an image of the surface data using a camera or wireless image capture device, and or generating a dataset from the surface data by the reading process, and outputting said generated dataset to a processing device,
or sending the dataset to a remote server for analysis,
or displaying the dataset on a screen, and decoding said dataset to determine the correct printed surface information comparing said decoded dataset with the printed surface information,
or further reading by said optical reading device said surface information and automatically comparing it with said generated dataset.

31. A method for encoding and authenticating documents comprising the steps of:
analysing a datagram in the form of a matrix perforation or of an encoded Optically Variable Device (OVD) by a device reading, determining a correct correspondence between said datagram and said surface-printed information wherein the direct correspondence between the numbering on the surface of the document or CD or DVD or credit card and said datagram being very complex, and/or said datagram encoding and the relation to said surface-printed information remaining confidential.

32. A method for encoding and authenticating documents according to claim 31 wherein said step of analysing a datagram further comprising the step of processing said datagram encoding for extracting the data within it wherein said data being a derivative of the stored information.

33. A method for encoding and authenticating documents according to claim 32 further comprising the steps of:
when the dataset derived from the encoding does not match the surface-printed information, identifying said document as non-authentic, rendering said document void by subsequently encoding information into said document, and/or printing the word void across said document.
